(19) United States
(12) Patent Application Publication
(10) Pub. No.: US 2002/0177837 A1
(43) Pub. Date: Nov. 28, 2002

(54) Cassettes supporting intracranial perfusions

(76) Inventor: James C. Barnitz, Schwenksville, PA (US)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 10/131,617

(22) Filed: Apr. 24, 2002

Related U.S. Application Data
(60) Provisional application No. 60/286,057, filed on Apr. 24, 2001.

(51) Int. Cl. B01D 21/00

(52) U.S. Cl. 604/416; 604/251; 604/500; 210/800; 210/803; 210/120; 210/513

(57) ABSTRACT

Devices and kits for intracranial and other perfusions and methods of using the same including a container having a top and bottom including a flexible bag adapted to be suspended in top to bottom orientation and to hold, in a main chamber, a solution, suspension or emulsion filled up to a fill line, a first opening to the bag located below the fill line and adapted to be fitted to conduit, a second opening located below the fill line and adapted to be fitted to conduit, and a first fluid pathway incorporated into the bag adapted to conduct fluid pumped into the second opening from below the fill line to an outlet within the bag located above the fill line.

This application claims priority of U.S. Serial No. 60/286,057, filed Apr. 24, 2001.

The present invention relates to pumping machines and components thereof for aiding in providing liquids, including liquids that provide drugs, nutrients, and oxygen to tissue, including cerebral tissue, and to associated methods.

Focal cerebral ischemia, or stroke, is the reduction or loss of blood flow to an area of cerebral tissue, denying the tissue sufficient oxygen and other metabolic resources. Similarly, during Traumatic Brain Injury (TBI) and Spinal Cord Injury (SCI) the tissues are also denied sufficient oxygen and other metabolic resources to carry out normal function or survive. Technology that has been explored by Osterholm has identified the cerebral spinal pathway, a connected system of cerebral ventricles and subarachnoid spaces of the brain and spinal cord, as an alternative pathway for delivering oxygen and nutrients to the tissue potentially affected by stroke. This stratagem has been shown in animal models for stroke to remarkably limit damage caused by focal cerebral ischemia.

The approach operates by placing a ventricular catheter into a lateral cerebral ventricle for use in administering an oxygenated fluorocarbon nutrient emulsion into the cerebral spinal pathway. The oxygenated fluorocarbon nutrient emulsion typically is made up of an emulsified fluorocarbon composition, where the fluorocarbon efficiently dissolves and carries gases, such as oxygen and carbon dioxide. The composition typically further contains additional nutrients. A second catheter is placed to allow drainage of fluid in the cerebral spinal pathway as needed in view of the injected fluorocarbon composition.

The applicants have discovered the importance of maintaining the fluorocarbon nutrient emulsions or other compositions in homogenized and temperature controlled form during delivery of the nutrient compositions to patients. Many emulsions tend to settle over time; accordingly, the failure to maintain homogeneity can result in the failure to deliver nutrients to the patient in the desired proportions. The failure to control the temperature of the composition can result in changes to the patient's brain temperature, with serious adverse consequences.

Moreover, there is a need for devices and kits that assure that nutrient composition is appropriately conditioned, and minimize the risk that a medical worker can inadvertently mis-connect the device or kit, yielding adverse consequences.

### SUMMARY OF THE INVENTION

In one embodiment, the invention provides a container having a top and bottom including a flexible bag adapted to be suspended in top to bottom orientation and to hold, in a main chamber, a solution, suspension or emulsion filled up to a fill line, a first opening to the bag located below the fill line and adapted to be fitted to conduit, a second opening located below the fill line and adapted to be fitted to conduit, and a first fluid pathway incorporated into the bag adapted to conduct fluid pumped into the second opening from below the fill line to an outlet within the bag located above the fill line.

In another embodiment, the invention provides a method of mixing or preventing stratification in the above container including pumping suspension or emulsion out of the first opening, and returning the pumped suspension or emulsion to the second opening, wherein the slope of the bottom of the main chamber is adapted for use with a particular suspension or emulsion and particular rates of pumping and return, the slope selected to minimize settling of higher density material in the suspension or emulsion.

In another embodiment, the invention provides a method of conditioning and delivering a solution, suspension or emulsion from a container including operating a conditioning circuit pump to pump the solution, suspension or emulsion from a first opening to (i) a conditioning unit that is a heat exchanger or a gas exchanger then (ii) a T-coupling, at least for a period of time during the operation of the conditioning circuit pump, operating a delivery pump at a pump rate lower than the pump rate of the conditioning circuit pump to draw solution, suspension or emulsion from the T-coupling for delivery to a site needing the solution, suspension or emulsion appropriately conditioned for temperature or gas tension, wherein the portion of the solution, suspension or emulsion not drawn from the T-coupling by the delivery pump is returned to the bag via the second opening, and at least for a period of time during the operation of the delivery pump, operating a return pump at a pump rate higher than the pump rate of the delivery pump to draw solution, suspension or emulsion that has been previously delivered to the site to a second T-coupling having two outlet conduits for delivery, depending on the outlet conduit used, to the third opening for reinsertion into the container or to a waste vessel.

In another embodiment, the invention provides a method of mixing or preventing stratification in the above container including pumping solution, suspension or emulsion out of the first opening, and returning the pumped solution, suspension or emulsion to the second opening.

In another embodiment, the invention provides a method of mixing or preventing stratification within a solution, suspension or emulsion, including pumping solution, suspension or emulsion into a bag with a sterile vent such that entering solution, suspension or emulsion is brought above the level of emulsion already within the sealed bag, and pumping solution, suspension or emulsion out of the sealed bag from the bottom of the sealed bag.

In another embodiment, the invention provides a method of conditioning and delivering a solution, suspension or emulsion from the above container including operating a conditioning circuit pump to pump the solution, suspension or emulsion from the first opening to (i) a conditioning unit that is a heat exchanger or a gas exchanger then (ii) a T-coupling, and at least for a period of time during the operation of the conditioning circuit pump, operating a delivery pump at a pump rate lower than the pump rate of the conditioning circuit pump to draw solution, suspension or emulsion from the T-coupling for delivery to a site needing the solution, suspension or emulsion appropriately conditioned for temperature or gas tension, wherein the portion of the solution, suspension or emulsion not drawn from the T-coupling by the delivery pump is returned to the bag via the second opening.

In another embodiment, the invention provides a disposable cassette kit, adapted to operate with (i) a console comprising a conditioning peristaltic pump and a delivery peristaltic pump and (ii) a reservoir comprising a first opening and a second opening, the reservoir adapted for mounting on the console, the kit including a resilient casing having an external facing, an internal facing adapted to rest against the console, and an interior space adapted to support and direct fluid conduits, wherein the casing is adapted for mounting on the console below the reservoir, one or more alignment slots or pegs that fit mating alignment slots or pegs in the console to correctly orient the casing, a first conduit from the first opening, extending through the interior space to exit the casing at a position adapted to be proximate to the conditioning peristaltic pump, the first conduit either adapted to connect with or connected with an intake of a conditioning unit that is a heat exchanger or a gas exchanger, a second conduit adapted to connect with or connected with an outlet of the conditioning unit and extending from such connection to the interior of the casing where it links to a first branch of a T-coupling, the T-coupling further comprising a second branch connecting to the second opening and a third branch connecting to a third conduit, and the third conduit extending from the third branch to exit the casing at a position adapted to be proximate to the delivery peristaltic pump.

In another embodiment, the invention provides a disposable cassette kit, adapted to operate with (i) a console comprising a delivery peristaltic pump and (ii) a reservoir comprising an opening, the reservoir adapted for mounting on the console, the kit including a resilient casing having an external facing, an internal facing adapted to rest against the console, and an interior space adapted to support and direct fluid conduits, wherein the casing is adapted for mounting on the console below the reservoir, one or more alignment slots or pegs that fit mating alignment slots or pegs in the console to correctly orient the casing, a pathway of conduit from the first opening, wherein a segment of conduit of the pathway exits the casing, provides a loop of conduit external to the casing at a position adapted for insertion into the delivery peristaltic pump, reinserts into the casing, and connects to a heat exchanger integrated into the casing, the heat exchanger which (a) comprises a gasket for sealing a heat exchange fluid portion of the heat exchanger with a source of heat exchange fluid in the console or (b) is adapted to seat on a gasket provided by the source of heat exchange fluid, and a latch for attaching the casing to the console, the latch integrated into the heat exchanger and effective, when latched, to sealably seat the gasket.

In another embodiment, the invention provides a disposable cassette kit, adapted to operate with (i) a console comprising a delivery peristaltic pump and (ii) a reservoir comprising an opening, the reservoir adapted for mounting on the console, the kit including a resilient casing having an external facing, an internal facing adapted to rest against the console, and an interior space adapted to support and direct fluid conduits, wherein the casing is adapted for mounting on the console below the reservoir, one or more alignment slots or pegs that fit mating alignment slots or pegs in the console to correctly orient the casing, a pathway of conduit from the first opening, wherein a segment of conduit of the pathway exits the casing, provides a loop of conduit external to the casing at a position adapted for insertion into the delivery peristaltic pump, reinserts into the casing, and connects to a heat exchanger integrated into the casing, the heat exchanger, a second pathway of conduit from the heat exchanger, and a plate, integral to the casing, of thermally conductive material in thermal connection with fluid of the second pathway, the plate adapted to compress against a temperature sensor seated on the console.

### BRIEF DESCRIPTION OF THE DRAWINGS

FIG. 1 displays the catheter placements for a venticulo-lumbar perfusion.

FIG. 2 displays an exemplary container for holding a nutrient composition.

FIG. 3 displays a first view of a portion of an exemplary pumping apparatus for aiding in delivering a nutrient composition to a patient.

FIG. 4 displays a second view of a portion of an exemplary pumping apparatus for aiding in delivering a nutrient composition to a patient.

FIG. 5 displays a third view of a portion of an exemplary pumping apparatus for aiding in delivering a nutrient composition to a patient.

FIG. 6 shows a reservoir bag with an increased bottom slope.

FIGS. 7A and 7B illustrate pinch valves formed by the cassette and the console.

FIGS. 8A and 8B illustrate automated coupling for temperature monitors.

FIG. 9 shows a reflux extension for a reservoir bag.

### DETAILED DESCRIPTION OF THE INVENTION

Method of Delivering Fluorocarbon Nutrient Emulsion

Despite the safety of the emulsions of poly-fluorinated, oxygen-carrying compound preferred for use in the invention, it has now been recognized as preferable to establish a flow pathway from the entry catheter (e.g., a ventricular catheter into a lateral ventricle of the brain) to an exit point at a different location in the cerebral spinal pathway (e.g., into the intrathecal space of the lumbar (L4-L5) region of the spine) without prematurely inserting the emulsion.

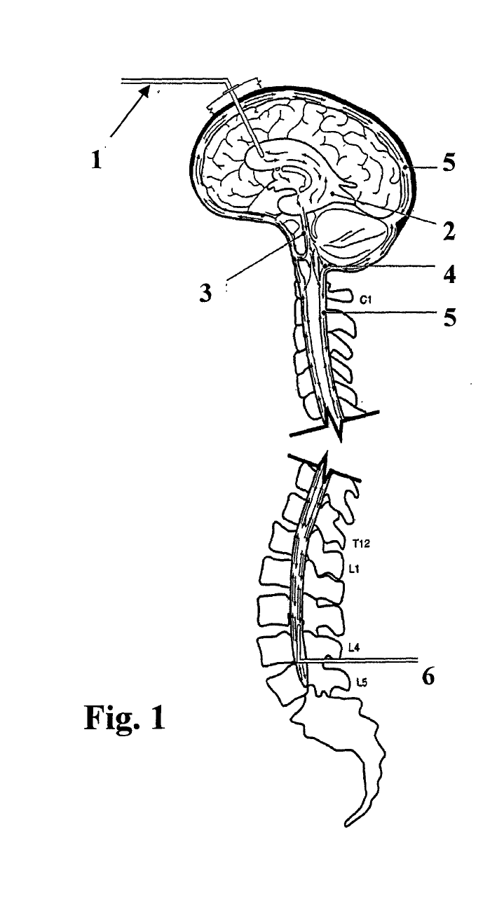

As illustrated in FIG. 1, a ventricular catheter 1 is inserted into a lateral ventrical 2. Via aqueduct 3, cisterna magna 4 and subarachnoid spaces 5, a flow pathway can be established to a lumbar outflow catheter 6. When the inflow and outflow catheters are established (typically with suitable controls to monitor intracranial and intraspinal pressure), vehicle can be used to establish the existence of a flow pathway (such as that illustrated) from the inflow catheter to the outflow catheter. Preferably, the vehicle is infused under gravity feed, with the pressure head designed to avoid excessive intracranial pressure. Once established, the vehicle can be substituted with the emulsion of poly-fluorinated, oxygen-carrying compound.

It is for this use that the perfusion devices and kits of the invention are most preferably used. However, those of skill in the art will recognize that these devices and kits can be used in any context in which tissue is perfused, for instance with a nutrient, pharmaceutical, gene therapy, or other composition. Among other preferred uses in perfusion are those in which the pathway contacting perfused tissue is of comparable volume to the cerebral spinal pathway, and those in which temperature equilibration or gas tension equilibration are important. These uses include perfusions of transplant tissue, and perfusions of an organ isolated from the native vasculature during the course of an operation.

Exemplary Perfusion Device

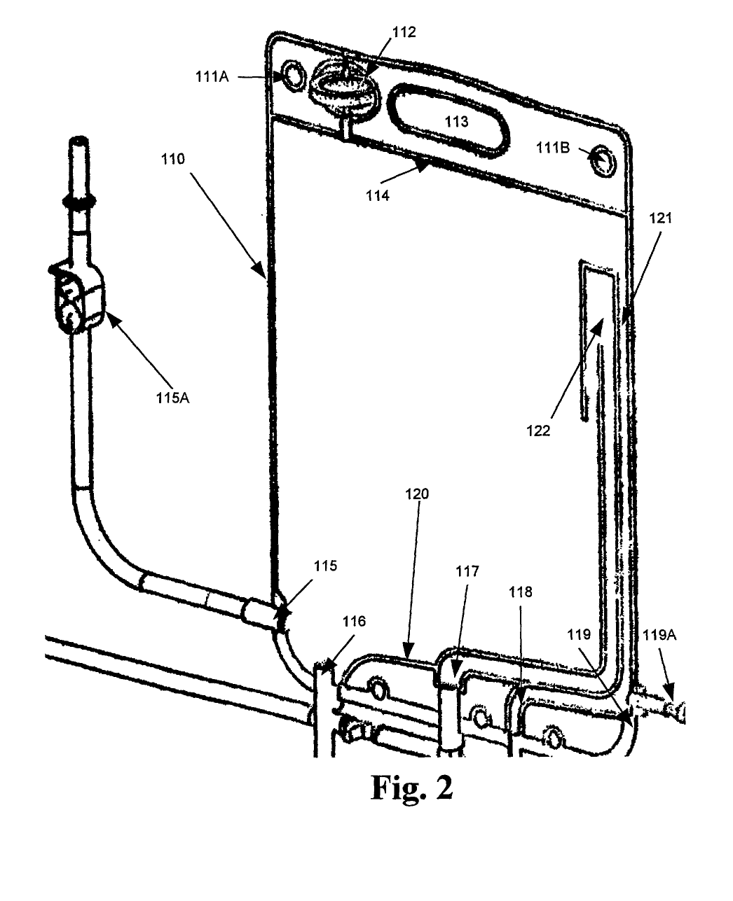

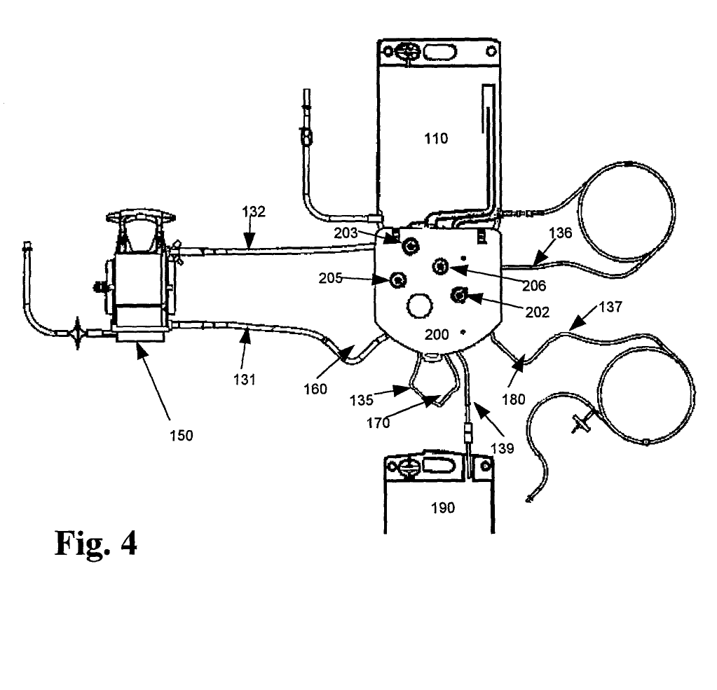

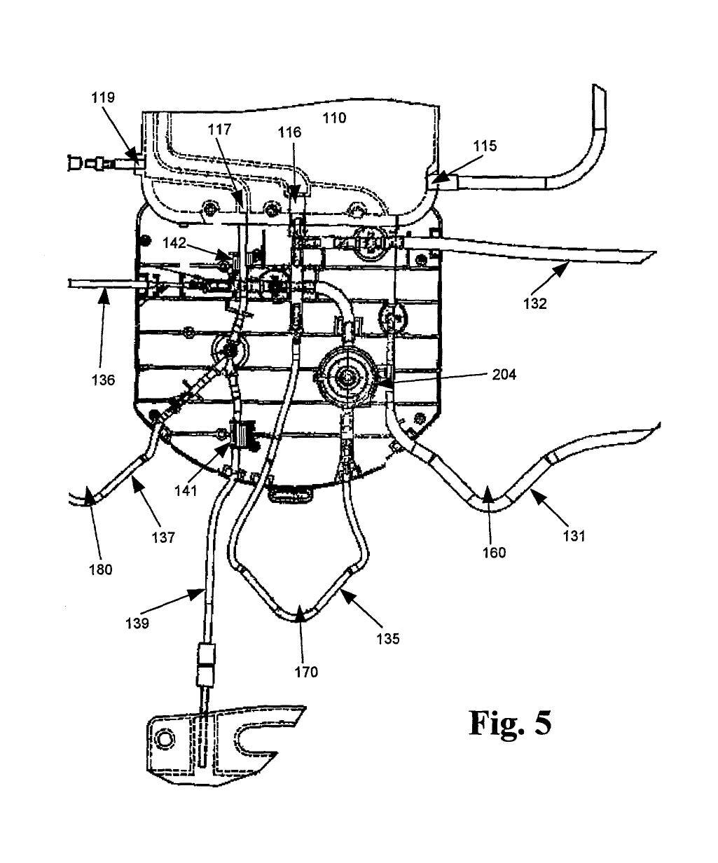

FIGS. 2 through 5 illustrate certain portions of an exemplary perfusion device. In certain preferred embodiments hereunder, portions of the perfusion device are disposable, especially those portions coming into direct contact with the patient or the nutrient composition pumped through the patient's body, for reasons of hygiene, and other portions of the perfusion device are reused for reasons of economy. In the exemplary embodiment, a cassette, including tubing, and one or two bags are disposable, while a console, to which the disposable components are attached, is not. Providing all of the primary disposables in a cassette kit facilitates sterilizing these components, for instance by gas (e.g., ethylene oxide) or radiation sterilization. Such sterilization is critical to many of the perfusion uses of the cassette kit.

Referring to FIG. 2, a reservoir bag 10 for holding a nutrient composition to be delivered to a patient is displayed. The material forming reservoir bag 110 can comprise a polymer and can be radio frequency (“RF”) or heat sealed, or sealed by use of solvent sealing, ultrasonic sealing, or other methods recognized in the art, and can be flexible. In certain embodiments, the polymer is non-plasticized or the bag contains a liner comprising a non-plasticized polymer. In the exemplary embodiment, the reservoir bag, and the tubing described below, is transparent, which allows a user to observe the level of fluid in the bag, the degree to which settling has occurred, and the presence of any air bubbles. The material of the reservoir bag, and of the tubing described below, can optionally comprise material blocking certain forms of light, such as ultraviolet light. In particular, such material may block near or far ultraviolet light. The blocking of ultraviolet light is desirable in embodiments in which a light-sensitive substance is added to the nutrient composition prior to delivery to the patient.

In the exemplary embodiment, the reservoir bag is held in a vertical position by inserting two pegs on a mount extending from a console (not shown) through two holes 111A and 111B. Those skilled in the art will appreciate that the bag can be attached to the console or otherwise held in an upright position by a greater or lesser number of holes or by other means. The vertical orientation of the bag is desirable, however, to aid in homogenization of the nutrient composition. The exemplary reservoir bag also comprises (i) air vent 112, which allows excess gas to escape to the atmosphere and is preferably filtered, (ii) handle 113, to facilitate handling of the reservoir bag when not attached to the console, and (iii) rod 114, which aids in preserving the shape of the reservoir bag during use. Rod 114 can be a fully rigid rod, such as a steel or other metallic rod, or may be a flexible rod, such as a plastic rod, and can be either solid or hollow. In certain embodiments, rod 114 can be an integral part of the reservoir bag, while in other embodiments, the reservoir bag can contain a sleeve into which a separate rod can be inserted. Optional rod 114 helps the relatively heavy bag (e.g., 2 to 4 L capacity) maintain an appropriate shape, facilitating the functions described below.

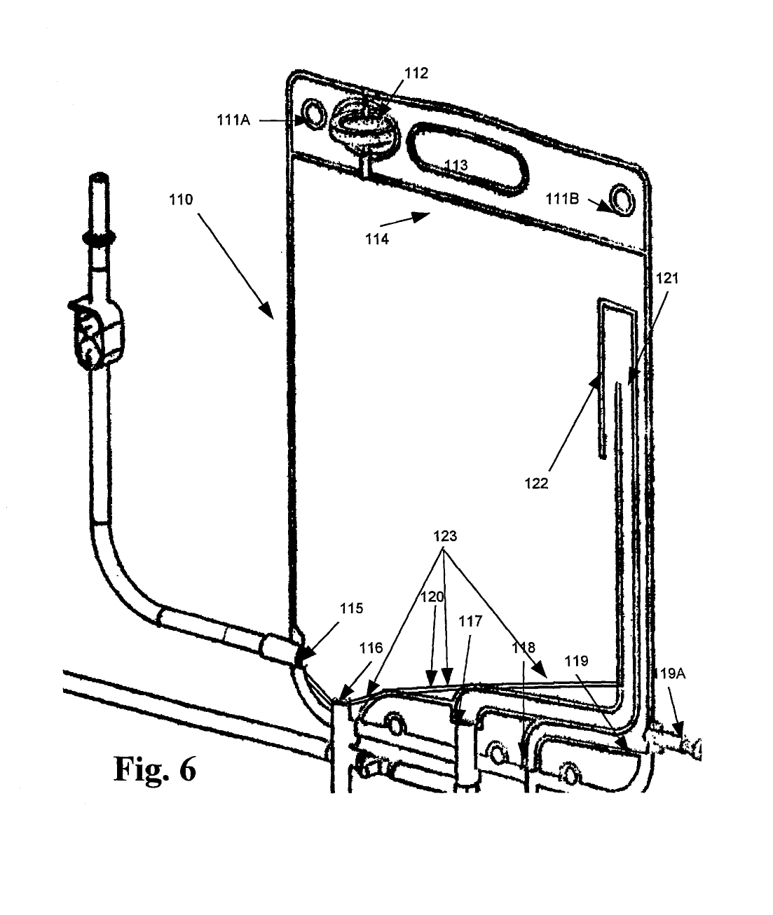

The exemplary reservoir bag contains at least five openings for fluid, compounding opening 115, exit 116, conditioning return 117, recirculating return 118, and priming return 119. One or more of compounding opening 115, conditioning return 117, recirculating return 118, and priming return 119 can incorporate or be connected to check valves to allow fluid to flow into, but not out of, the reservoir bag through such opening or openings. Check valve 119A illustrates a positioning for such a check valve. Each of the openings is preferably attached to a conduit, such as tubing, which can be transparent ethyl vinyl acetate (“eva”) lined tubing and can optionally provide ultraviolet or other light protection, as described above. Compounding opening 115 can be used to add components to the nutrient composition in the bag, or initially fill the bag for use. The conduit attached to compounding opening 115 preferably leads to a valve or other means for preventing the escape of the nutrient composition from the reservoir bag, such as pinch valve 115A. Exit 116 is preferably located at the bottom of the slope of interior surface 120 and thus exit 116 is located at the lowest position in the bag to which fluid can sink without exiting the reservoir bag. Interior slope 120 can be formed by heat or RF sealing and can constitute a straight slope, a curved slope, or a stepped slope. In some embodiments hereunder, the angle of the slope is selected to minimize the settling of higher density materials in a particular suspension or emulsion that the reservoir bag is specifically designed to contain. FIG. 6 illustrates a reservoir bag with additional heat seals 123 that increase the slope.

Conditioning return 117 leads into conditioning channel 122, which can be of the general shape of an upside down “U”. Conditioning channel 122 and other channels in the bag are illustrated as formed with heat seals 123. Preferably, the level of fluid in the reservoir bag when in use is always lower than the exit from conditioning channel 122. Accordingly, the conditioned nutrient composition returning to the reservoir bag after conditioning enters the bag above the level of the nutrient composition already within the bag, causing constant mixing and limiting or preventing settling and dehomogenization. A preferred mode of operating recirculates the major share of nutrient composition (e.g., a 4:1 or 6:1 or greater ratio) while drawing off a smaller portion for use. This recycling, in conjunction with other features of the reservoir bag, enhances mixing, including particle, temperature and component mixing. More general component mixing can be important to maintaining the homogeneity of liquid recycled through the site of use.

Recirculating return 118 leads into recirculating channel 121. Recirculating channel 121, which can be of the general shape of an upside down “J”, similarly to conditioning channel 122 returns recirculated fluid above the level of the fluid already within the reservoir bag, causing constant mixing and limiting or preventing settling and dehomogenization. The more open shape of recirculating channel 121, however, allows excess gas easily to collect at the top of the reservoir bag and escape through air vent 112. Priming return 119 also leads into recirculating channel 121.

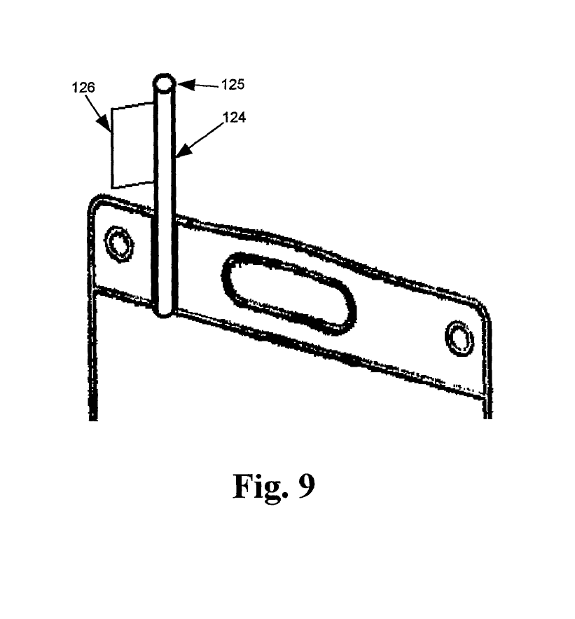

The reservoir bag optionally contains, or incorporates an additional opening that can be attached to an additional tube 124 (FIG. 9) leading from a portion of the reservoir bag above the fill line of the fluid contained in it to a sterile filter. The end 125 of the tube 124 can be fitted with a sterile filter. The tube provides a reflux surface adapted to increase the likelihood that water vapor condenses prior to reaching the sterile filter. In one embodiment, the tube can be fully or partially jacketed with a heat exchange element. In one embodiment, the jacket is formed of a heat transmitting substance and has heat dissipating vanes (e.g., vane 126).

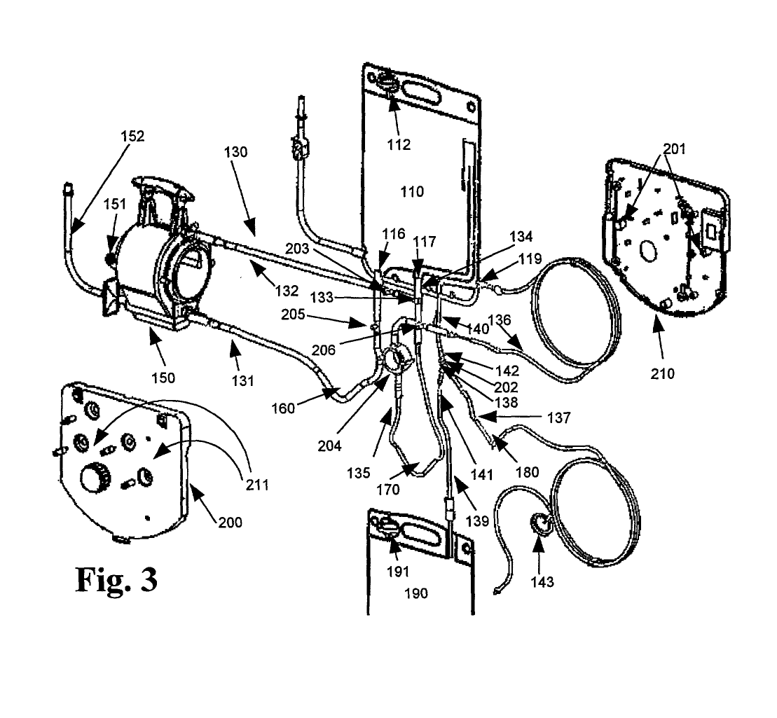

Referring to FIGS. 3, 4, and 5, in an exemplary embodiment, cassette 100 includes cassette shell 200, tubing 130, heat exchanger 204, sampling ports 202 and 203, temperature monitoring ports 205 and 206, and pegs 201. In the exemplary embodiment, tubing 130 includes at least tubing elements 131, 132, 134, 135, 136, 137, 139, and 140. Cassette 100 is attached by slots 201 (shown from the rear of the molding) to console 210 and by tubing 130 to reservoir bag 110 and gas exchanger 150 and optionally to waste bag 190. In the exemplary embodiment, cassette 100 is disposable and is configured both so as to minimize the number of steps necessary to connect it to console 210, reservoir bag 110, gas exchanger 150, and optionally waste bag 190, and so as to simplify each such step. In one embodiment, the user need only insert pegs 201 into slots 211 (not visible in figures) on console 210 and attach tubing 130 to reservoir bag 110 and gas exchanger 150 and optionally to waste bag 190. Moreover, in this embodiment, once pegs 211 have been inserted into slots 201, the ends of tubing 130 are located near the elements to which they must be attached, decreasing the likelihood that the user will connect the wrong portion of tubing to an opening. Any number of alignment pegs (and a corresponding number of alignment slots in the console) can be used. In fact, the entire cassette can fit into a large slot on the surface of the console. Moreover, the alignment pegs can be of a standard geometrical shape, such as circular, or can be molded pegs of a regular or irregular shape. In certain embodiments, other steps, such as tightening heat exchanger 204 may also be necessary. Such tightening may consist of or comprise closing a latch thereby sealing a gasket. In one embodiment, such tightening serves to seat a gasket by which heat exchanger 204 is connected in a fluid-tight manner to plumbing to a temperature conditioner (not shown).

The cassette, gas exchanger 150 (which includes an incorporated heat exchanger), reservoir bag, the tubing described with reference to FIGS. 3-5, and waste reservoir comprise one preferred embodiment of a “cassette kit” that packages all or a useful portion of the disposables used in treating a patient. In this exemplary embodiment, sampling ports 202 and 203 can each comprise a septum into which sampling devices, such as syringes or catheters, can be inserted. In addition temperature monitoring ports 205 and 206 can comprise hollow sleeves into which thermisters or thermocouples can be inserted.

Referring to FIG. 3, conditioning pump 160 on console 210 pumps the nutrient composition from reservoir bag 110 through exit 116 into tubing portion 131 into gas exchanger 150. Conditioning pump 160 can be a peristaltic pump. A heat exchanger integrated into gas exchanger 150 regulates the temperature of the nutrient composition to maintain an appropriate temperature (to achieve physiologic pH and an appropriate tension of carbon dioxide for buffering) during oxygenation of the nutrient composition in gas exchanger 150. In an exemplary embodiment that temperature is approximately thirty-seven degrees centigrade. As a safety measure, a second heat exchanger can lower the temperature to avoid increasing the temperature above physiologic temperature. Temperature probes at the entrance to and the exit from gas exchanger 150 can be used to calculate the bulk temperature of the nutrient composition within gas exchanger 150. In an exemplary embodiment, gas exchanger 150 includes a corrugated bellows through which heat exchange fluid is pumped through nipple 151 from a heat exchange conditioner (not shown, e.g., located within the console) with a heater element. The bellows are surrounded by porous fibres through which the O₂/CO₂ gas is contacted with the nutrient composition. A gas exchanger that can be used in the exemplary embodiment is available from Lifestream, Inc. of Woodland, Tex. or Jostra, AG of Hirrlingen, Germany. The gas exchanger is connected through gas intake tube 152 in this embodiment to a standard six hundred liter gas tank (not shown) containing a premixed 4-7:96-93 carbon dioxide-oxygen mixture. The coupling to the gas tank is preferably made with an industry accepted safety coupling, such as CGA medically indexed coupling. Gas pressure or flow rate can be monitored, with the values relayed to a controller, such that values indicative of failed couplings, a blockage, or low supply can be flagged. Though less preferred, oxygen and carbon dioxide can be mixed from separate tanks.

The nutrient composition exiting gas exchanger 150 is pumped through tubing portion 132 to T-coupling 133, which is also connected both to tubing portion 134 connected to conditioning return 117 and to tubing portion 135. Delivery pump 170, attached to tubing portion 135, is preferably operated at a lower rate than conditioning pump 160, resulting in a portion of the nutrient composition pumped to T-coupling 133 entering tubing portion 135 for delivery to the patient and the excess returning to the reservoir bag through conditioning return 117 and conditioning channel 122, maintaining homogenization within the reservoir bag as described above. Delivery pump 170 pumps the nutrient composition within tubing portion 135 through heat exchanger 204 to tubing portion 136. Heat exchanger 204 receives heat exchange fluid from a second heat exchange conditioner (not shown, e.g., located within the console). Since heat exchanger 204 is typically adjusted to lower the temperature from that a which oxygenation occurs, a cooling unit as well as a heater is preferably incorporated into the second heat exchange conditioner.

A ventricular catheter (not shown) can be attached to tubing portion 136 to enable delivery of the nutrient composition to the patient. In the absence of a ventricular catheter, the nutrient composition is pumped back into the reservoir bag through tubing portion 136 to priming return 119, which is connected to recirculating channel 121. This latter flow route can be used during priming to assure that air pockets are flushed from the tubing.

Nutrient composition perfused through the patient exits the patient through a lumbar catheter, not shown, which is connected to tubing portion 137. Recirculating pump 180, which may be a peristaltic pump, pumps the exiting nutrient composition through tubing portion 137 to T-coupling 138, which is connected to tubing portions 139 and 140. Pinch valve 141 can be used to block tubing portion 139 and pinch valve 142 can be used to block tubing portion 140. Tubing portion 139 is connected to waste bag 190, while tubing portion 140 is connected to recirculating return 118, which leads into recirculating channel 121. By closing pinch valve 142 and opening pinch valve 141, the exiting nutrient composition can be pumped into waste bag 190 if the user does not desire to reuse the nutrient composition that has exited the patient's body. By closing pinch valve 141 and opening pinch valve 142, the exiting nutrient composition can be returned to the reservoir bag for reuse if such reuse is desired by the user.

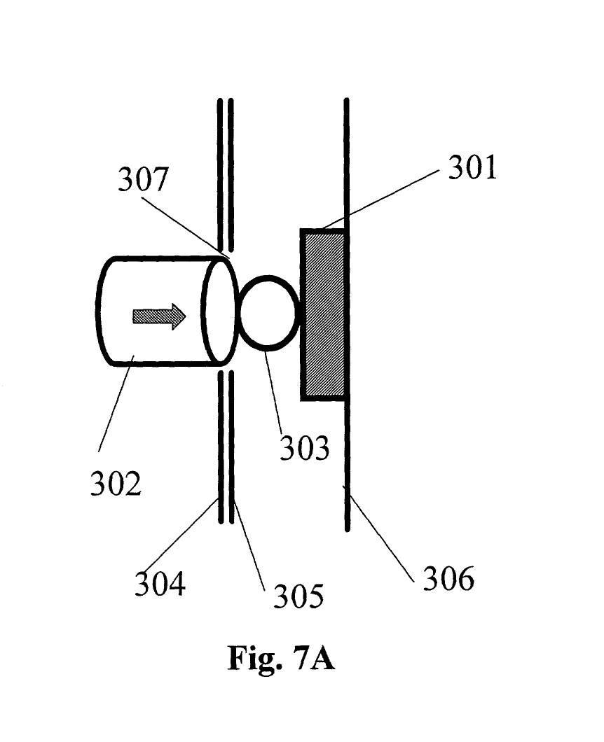

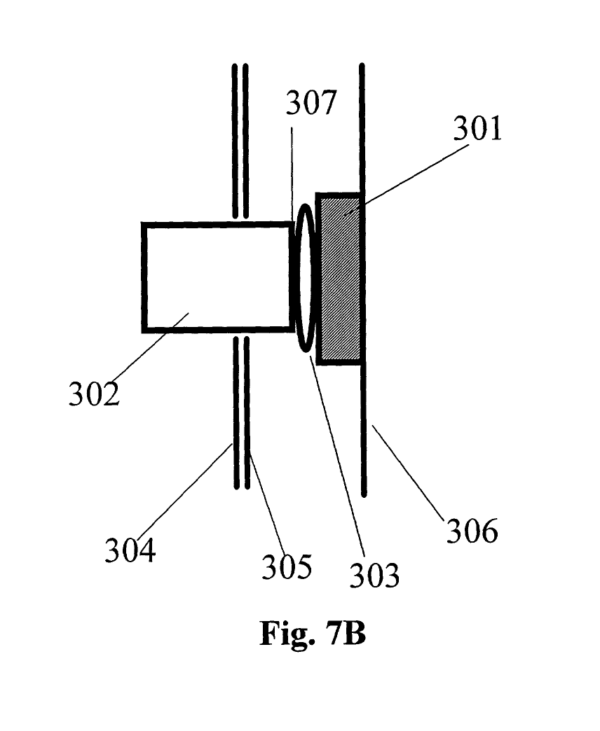

In a preferred embodiment, pinch valves backings 301 are provided in the cassette that operate with plungers 302 from the console to form pinch valves 141 or 142 (see FIGS. 7A and 7B). In FIGS. 7A and 7B, tubing 303 is squeezed shut by the action of plunger 302 acting in the indicated direction. Plunger 302, when activated, projects out of the front facing 304 of the console, through hole 307 in rear facing 305 of the cassette, to push against backing 301 supported by front facing 306 of the cassette. The plungers can be powered by solenoids, electric motors, other electrical actuating devices, hydraulics, or the like.

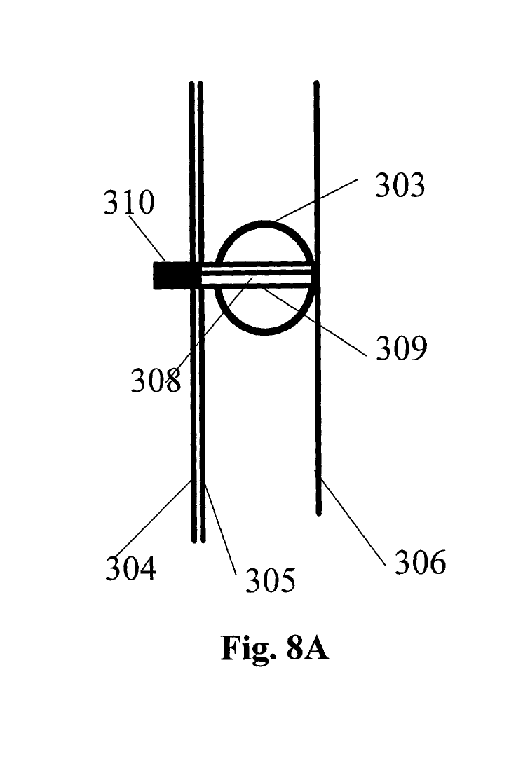

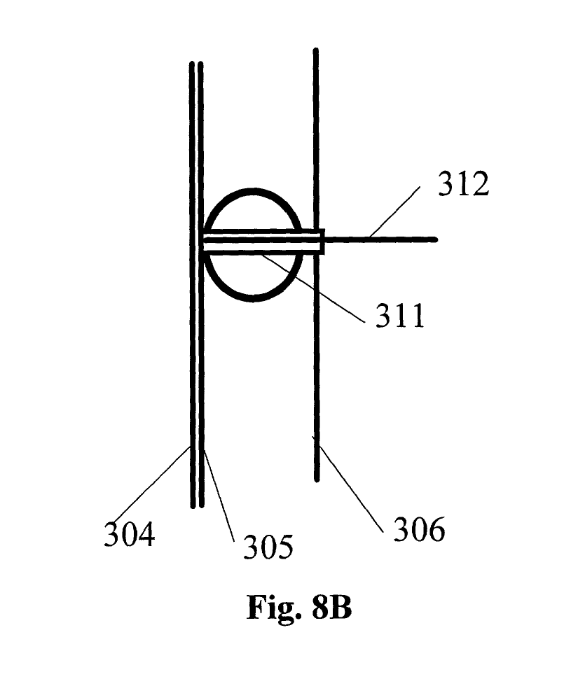

In a preferred embodiment, temperature monitoring ports 205 and 206 are adapted to connect a temperature conductive element 308, which may be seated within tubing 303 in a sleeve 309, to a temperature probe 310 seated on the console. FIG. 8A. The temperature probe can be a thermistor, thermocouple, or the like. This type of connection assures that a given temperature probe is always correctly wired to a controller, as the alignment pegs for the cassette assure correct connection of the temperature probes. In another preferred embodiment, sleeve 309 is omitted such that temperature monitoring ports 205 and 206 are adapted to connect a temperature conductive element 308, which can be in direct contact with the fluid, to a temperature probe 310 seated on the console. In yet another embodiment, temperature monitor 312 is inserted into sleeve 311. FIG. 8B.

In certain cases it is desirable during an initial period to operate the apparatus to discard nutrient composition exiting from the cerebral spinal pathway, and subsequently to operate the apparatus so as to reuse exiting nutrient composition. For example, the apparatus can be operated in discard mode until a predetermined amount of time has elapsed, a predetermined volume of nutrient composition has been pumped through the patient's body, or until the exiting nutrient composition has certain characteristics, which can be determined optically, chemically (through use of the sampling ports), or otherwise. For example, it may be desired by the user to flush the perfused body tissue of native fluid, which can be determined by chemically monitoring the nutrient compound by monitoring a component thereof, such as glucose.

Recirculating pump 180 can be run at a faster rate than delivery pump 170, in which case air entering through filter 143 can be used to equalize pressure. The excess air then exits the system through air vent 112 after return of the nutrient composition to the reservoir bag or through air filter 191 after delivery of the nutrient composition to the waste bag. Use of the faster rate for the recirculating pump and the air intake protects against a phenomenon (and risk) involved in recycling the liquid that has cycled through the cerebral spinal pathway. A mismatch in inflow and outflow rates can occur, resulting from the tolerances in the two pumping systems, a difference in CSF production and absorption, or a change in ICP and the concurrent change in CNS volume due to compliance in the CNS. Such a mismatch could lead to an over or under pressure condition in the patient.

Sampling ports are attached to tubing portions 136 and 137 respectively and can be used to draw samples of the nutrient composition for analysis or to inject substances, such as medications, into the nutrient composition.

In certain embodiments, a cassette present indicator (not shown) may form a part of the console. A pressure sensor, photosensor, or other sensor can be used to detect whether the cassette has been correctly attached to the console and an indicator, such as a light-emitting diode or a mechanical switch can be used to indicate such information to the user. Such indicators or sensors typically send the appropriate detection signal to a controller.

Prior to use of the apparatus to deliver a nutrient composition to a patient, the apparatus is preferably primed. During priming, at least the conditioning pump is operated to oxygenate the nutrient composition (the heat exchangers establishing an appropriate temperature for the nutrient composition) and the nutrient composition is cycled between the reservoir bag and the gas exchanger. Optionally, the delivery pump is operated as well (with no catheter attached to tubing portion 136, pinch valve 142 open, and pinch valve 141 closed) to cycle nutrient composition through other portions of the tubing as well. During priming, the operated pump or pumps are preferably operated initially at a slow speed to minimize the formation of air bubbles and subsequently at a higher speed to flush any air bubbles from the apparatus.

Preferably, the system defined by the console, cassette and associated hardware is designed as illustrated so the gravity-fed initial priming fills devices with large internal cavities from the bottom up, thereby assuring that slow filling will minimize air pockets. Elements that can be initially primed by gravity feed include the gas exchanger 150 and heat exchanger 204.

Methods of operating devices for perfusing the cerebral spinal pathway are described for example in U.S. Serial No. 60/286,063, filed Apr. 24, 2001 and its successor application U.S. Serial No. __/___,___, filed concurrently herewith. These applications are incorporated by reference herein in their entirety.

Information on Fluorocarbon Nutrient Emulsions

Information on fluorocarbon nutrient emulsions can be found, for example, in U.S. Pat. Nos. 4,378,797; 4,393,863; 4,446,154; 4,446,155; 4,657,532; 4,686,085; 4,758,431; 4,795,423; 4,830,849; 4,840,617; 4,963,130; 4,981,691; and 5,085,630, all to Jewell L. Osterholm. Further information can be found in U.S. patent application Ser. No. 09/619,414, filed Jul. 19, 2000.

Definitions

The following terms shall have, for the purposes of this application, the respective meanings set forth below.

exposed cerebral-spinal tissue. Exposed cerebral-spinal tissue is any cerebral-spinal tissue which can be accessed by surgical equipment, including micro-scaled equipment such as endoscopes.

nutrient-providing effective amount. A nutrient-providing effective amount of a substance is a amount that can be expected, provided sufficient amounts of other nutrients, to increase metabolism or reproduction of mammalian cells compared with nutrient solutions lacking that substance.

respiration. Respiration is the physical and chemical processes by which an organism supplies its cells and tissues with the oxygen needed for metabolism and, preferably, relieves them of the carbon dioxide formed in energy-producing reactions.

respiration-supporting amount. A respiration-supporting amount of oxygen is an amount that would, in model experiments, provide a statistically significant reduction in morbidity following a focal ischemic event.

All publications and references, including but not limited to patents and patent applications, cited in this specification are herein incorporated by reference in their entirety as if each individual publication or reference were specifically and individually indicated to be incorporated by reference herein as being fully set forth. Any patent application to which this application claims priority is also incorporated by reference herein in its entirety in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed is:

1. A container having a top and bottom comprising:
a flexible bag adapted to be suspended in top to bottom orientation and to hold, in a main chamber, a solution, suspension or emulsion filled up to a fill line;
a first opening to the bag located below the fill line and adapted to be fitted to conduit;
a second opening located below the fill line and adapted to be fitted to conduit; and
a first fluid pathway incorporated into the bag adapted to conduct fluid pumped into the second opening from below the fill line to an outlet within the bag located above the fill line.

2. The container of claim 1, further comprising:
a gas vent located above the fill line.

3. The container of claim 1, further comprising:
openings adjacent to the top adapted to receive pegs upon which the bag is suspended and a horizontal reinforcing support attached to said bag adapted to maintain an appropriate shape of the bag when suspended from the pegs.

4. The container of claim 3, wherein the horizontal reinforcing support is a solid or hollow rod.

5. The container of claim 1, wherein the material of said bag, or a layer of the material, comprises UV-absorbing material.

6. The container of claim 1, wherein the first fluid pathway is formed by sealing together portions of material forming the bag.

7. The container of claim 1, comprising a tube extending from the main chamber to a sterile filter, the tube adapted to increase the likelihood that water vapor condenses prior to reaching the sterile filter.

8. The container of claim 7, wherein, when the bag is suspended as adapted, heat or RF seal lines and the boundaries of the container define a bottom of the main chamber that slopes towards the first opening.

9. A method of mixing or preventing stratification in the container of claim 7, comprising:
pumping suspension or emulsion out of the first opening; and
returning the pumped suspension or emulsion to the second opening, wherein the slope of the bottom of the main chamber is adapted for use with a particular suspension or emulsion and particular rates of pumping and return, the slope selected to minimize settling of higher density material in the suspension or emulsion.

10. The container of claim 7, wherein at least a portion of the first fluid pathway comprises a tube formed along the side of the bag by at least one internal seal, and the outlet is downward facing due to a U-turn formed in the tube by one or more additional seals.

11. The container of claim 1, further comprising:
an equilibration opening located below the fill line and adapted to be fitted to conduit which is connected to a fluid pathway incorporated into the bag adapted to conduct fluid pumped into the second opening from below the fill line to an outlet within the bag located above the fill line, which fluid pathway can be the first fluid pathway.

12. The container of claim 11, further comprising:
a check-valve incorporated into the equilibration opening or connected conduit, which check-valve allows fluid flow into the bag but blocks outward flow.

13. The container of claim 1, further comprising:
a third opening located below the fill line and adapted to be fitted to conduit; and
a second fluid pathway incorporated into the bag adapted to conduct fluid pumped into the third opening from below the fill line to an outlet within the bag located above the fill line.

14. The container of claim 13, further comprising:
an equilibration opening located below the fill line and adapted to be fitted to conduit, which third opening is connected to one of the first or second fluid pathways.

15. The container of claim 13, further comprising:
a fourth opening located below the fill line and connected to flexible conduit.

16. A method of conditioning and delivering a solution, suspension or emulsion from the container of claim 13, comprising:
operating a conditioning circuit pump to pump the solution, suspension or emulsion from the first opening to (i) a conditioning unit that is a heat exchanger or a gas exchanger then (ii) a T-coupling;
at least for a period of time during the operation of the conditioning circuit pump, operating a delivery pump at a pump rate lower than the pump rate of the conditioning circuit pump to draw solution, suspension or emulsion from the T-coupling for delivery to a site needing the solution, suspension or emulsion appropriately conditioned for temperature or gas tension, wherein the portion of the solution, suspension or emulsion not drawn from the T-coupling by the delivery pump is returned to the bag via the second opening; and
at least for a period of time during the operation of the delivery pump, operating a return pump at a pump rate higher than the pump rate of the delivery pump to draw solution, suspension or emulsion that has been previously delivered to the site to a second T-coupling having two outlet conduits for delivery, depending on the outlet conduit used, to the third opening for reinsertion into the container or to a waste vessel.

17. The method of claim 16, further comprising:
monitoring the volume or properties of the fluid pumped by the return pump;
for an initial period routing that fluid to the waste vessel; and,
when monitoring identifies a match of the monitored criterion to a set point, routing the fluid to the container.

18. The method of claim 16, further comprising:
(a) operating the conditioning circuit pump with the delivery pump off to cycle solution, suspension or emulsion between the conditioning unit and the bag for a period of time effective to reach sufficient homeostasis as to temperature or gas tension; and
(b) thereafter operating the delivery pump while operating the conditioning circuit pump to provide (i) cycling of solution, suspension or emulsion between the conditioning unit and the bag and (ii) concurrent delivery to the site.

19. The method of claim 18, further comprising:
(c) prior to step (b), operating the delivery pump to flush a conduit used for delivery to the site, which conduit is during this step connected to an equilibration opening located below the fill line, which equilibration opening is connected to one of the first or second fluid pathways, thereby providing for the flush while cycling the solution, suspension or emulsion between the conditioning unit and the bag.

20. A method of mixing or preventing stratification in the container of claim 1, comprising:
pumping solution, suspension or emulsion out of the first opening; and
returning the pumped solution, suspension or emulsion to the second opening.

21. A method of mixing or preventing stratification within a solution, suspension or emulsion, comprising:
(a) pumping solution, suspension or emulsion into a bag with a sterile vent such that entering solution, suspension or emulsion is brought above the level of emulsion already within the sealed bag; and
(b) pumping solution, suspension or emulsion out of the sealed bag from the bottom of the sealed bag.

22. The method of claim 21, further comprising:
operating a pump returning solution, suspension or emulsion to the bag from a site of use at a higher flow rate than provided to the site of use, and adding sterile gas into the portion of the solution, suspension or emulsion thereby pumped into the bag to accommodate that higher flow rate.

23. A method of conditioning and delivering a solution, suspension or emulsion from the container of claim 1, comprising:
operating a conditioning circuit pump to pump the solution, suspension or emulsion from the first opening to (i) a conditioning unit that is a heat exchanger or a gas exchanger then (ii) a T-coupling; and
at least for a period of time during the operation of the conditioning circuit pump, operating a delivery pump at a pump rate lower than the pump rate of the conditioning circuit pump to draw solution, suspension or emulsion from the T-coupling for delivery to a site needing the solution, suspension or emulsion appropriately conditioned for temperature or gas tension, wherein the portion of the solution, suspension or emulsion not drawn from the T-coupling by the delivery pump is returned to the bag via the second opening.

24. The method of claim 23, wherein the conditioning unit comprises a first heat exchanger, the method further comprising:
passing the solution, suspension or emulsion drawn off by the delivery pump through a second heat exchanger adapted to condition the solution, suspension or emulsion to a lower temperature than provided by the first heat exchanger.

25. A disposable cassette kit, adapted to operate with (i) a console comprising a conditioning peristaltic pump and a delivery peristaltic pump and (ii) a reservoir comprising a first opening and a second opening, the reservoir adapted for mounting on the console, the kit comprising:
a resilient casing having an external facing, an internal facing adapted to rest against the console, and an interior space adapted to support and direct fluid conduits, wherein the casing is adapted for mounting on the console below the reservoir;
one or more alignment slots or pegs that fit mating alignment slots or pegs in the console to correctly orient the casing;
a first conduit from the first opening, extending through the interior space to exit the casing at a position adapted to be proximate to the conditioning peristaltic pump, the first conduit either adapted to connect with or connected with an intake of a conditioning unit that is a heat exchanger or a gas exchanger;
a second conduit adapted to connect with or connected with an outlet of the conditioning unit and extending from such connection to the interior of the casing where it links to a first branch of a T-coupling;
the T-coupling further comprising a second branch connecting to the second opening and a third branch connecting to a third conduit; and
the third conduit extending from the third branch to exit the casing at a position adapted to be proximate to the delivery peristaltic pump.

26. The disposable cassette kit of claim 25, wherein the third conduit loops back to the interior of the casing such that the looped portion is positioned for insertion into the delivery peristaltic pump.

27. The disposable cassette kit of claim 26, wherein the third conduit loops downwards as it exits the casing from the third branch and upwards from the delivery peristaltic pump.

28. The disposable cassette kit of claim 27, wherein the casing further comprises:
an integrated heat exchanger connected to the third conduit from below such that liquid flow from the third conduit tends to purge trapped gas from the integrated heat exchanger.

29. The disposable cassette kit of claim 25, further adapted to operate with a return peristaltic pump comprised in the console, and further comprising:
a fourth conduit exiting the casing at a position adapted to be proximate to the return peristaltic pump;
a second T-coupling interior to the casing connected to, at its respective branches, (i) the fourth conduit, (ii) a fifth conduit to a third opening to the reservoir, and (iii) a sixth conduit adapted to direct fluid to a waste vessel.

30. The disposable cassette kit of claim 29, further comprising:
a first backing for a push rod formed on the interior surface of the exterior facing and aligned with the fifth conduit, the first backing adapted to operate with a push rod that extends from the console and has a more fully extended position that, in conduction with the first backing, pinches the fifth conduit closed, and a less extended or a retracted position that opens the fifth conduit; and
a second backing for a push rod formed on the interior surface of the exterior facing and aligned with the sixth conduit, the first backing adapted to operate with a second push rod that extends from the console and has a more fully extended position that, in conduction with the second backing, pinches the sixth conduit closed, and a less extended or a retracted position that opens the sixth conduit.

31. The disposable cassette kit of claim 25, further adapted to operate with a return peristaltic pump comprised in the console, and further comprising:
a fourth conduit exiting the casing at a position adapted to be proximate to the return peristaltic pump and providing a segment adapted to thread into the peristaltic pump, the fourth conduit linked within the casing to conduit adapted to direct fluid to a waste vessel; and
a sterile filter branched from the fourth conduit at a position further distal from the casing than the threading segment.

32. A disposable cassette kit, adapted to operate with (i) a console comprising a delivery peristaltic pump and (ii) a reservoir comprising an opening, the reservoir adapted for mounting on the console, the kit comprising:
a resilient casing having an external facing, an internal facing adapted to rest against the console, and an interior space adapted to support and direct fluid conduits, wherein the casing is adapted for mounting on the console below the reservoir;
one or more alignment slots or pegs that fit mating alignment slots or pegs in the console to correctly orient the casing;
a pathway of conduit from the first opening, wherein a segment of conduit of the pathway exits the casing, provides a loop of conduit external to the casing at a position adapted for insertion into the delivery peristaltic pump, reinserts into the casing, and connects to a heat exchanger integrated into the casing;
the heat exchanger which (a) comprises a gasket for sealing a heat exchange fluid portion of the heat exchanger with a source of heat exchange fluid in the console or (b) is adapted to seat on a gasket provided by the source of heat exchange fluid; and
a latch for attaching the casing to the console, the latch integrated into the heat exchanger and effective, when latched, to sealably seat the gasket.

33. A disposable cassette kit, adapted to operate with (i) a console comprising a delivery peristaltic pump and (ii) a reservoir comprising an opening, the reservoir adapted for mounting on the console, the kit comprising:
a resilient casing having an external facing, an internal facing adapted to rest against the console, and an interior space adapted to support and direct fluid conduits, wherein the casing is adapted for mounting on the console below the reservoir;
one or more alignment slots or pegs that fit mating alignment slots or pegs in the console to correctly orient the casing;
a pathway of conduit from the first opening, wherein a segment of conduit of the pathway exits the casing, provides a loop of conduit external to the casing at a position adapted for insertion into the delivery peristaltic pump, reinserts into the casing, and connects to a heat exchanger integrated into the casing;
the heat exchanger;
a second pathway of conduit from the heat exchanger; and
a plate, integral to the casing, of thermally conductive material in thermal connection with fluid of the second pathway, the plate adapted to compress against a temperature sensor seated on the console.

34. The disposable cassette kit of claim 33, wherein the first pathway of conduit comprises a segment that connects to a conditioning unit that is a heat exchanger and a gas exchanger, the casing further comprising:
a second plate of thermally conductive material in thermal connection with fluid of the first pathway and located after the conditioning unit, the plate adapted to compress against a second temperature sensor seated on the console.
